(19) United States
(12) Patent Application Publication
(10) Pub. No.: US 2020/0364608 A1
(43) Pub. Date: Nov. 19, 2020

(54) COMMUNICATING IN A FEDERATED LEARNING ENVIRONMENT

(71) Applicant: INTERNATIONAL BUSINESS MACHINES CORPORATION, Armonk, NY (US)

(72) Inventors: Ali Anwar, San Jose, CA (US); Yi Zhou, San Jose, CA (US); Nathalie Baracaldo Angel, San Jose, CA (US); Heiko H. Ludwig, San Francisco, CA (US)

(21) Appl. No.: 16/411,090

(22) Filed: May 13, 2019

(51) Int. Cl. G06N 20/00

(52) U.S. Cl. CPC G06N 20/00

(57) ABSTRACT

A computer-implemented method of communicating in a federated learning environment includes an aggregator and a plurality of federated learning participants that respectively maintain their own data and communicate with the aggregator. The aggregator monitors the plurality of federated learning participants for factors associated with stragglers. The federated learning participants are assigned into tiers based on the monitoring of the factors. The aggregator queries the federated learning participants in a selected tier and designates late responders as stragglers. Maximum waiting time may be defined for each tier. The aggregator applies a predicted response for drop outs including collected participants' replies and computed predictions associated with the stragglers to update a training of a federated learning model. The federated learning participants that do not respond within the designated wait time are designated as drop outs. The training of the federated learning model is updated with collected participants' replies and computed predictions associated with the drop outs.

### BACKGROUND

### Technical Field

The present disclosure generally relates to federated learning, and more particularly, to communicating between an aggregator and federated learning participants.

### Description of the Related Art

In a federated learning system, multiple data sources collaborate to learn a predictive model. Such collaboration leads to more accurate models than any party owning one such source could learn in isolation. Whereas in machine learning a trusted third party typically accesses data from multiple parties in the same place, in federated learning each data owner (e.g. federated learning participant) maintains its data locally and communicates with an aggregator. Thus, the aggregator collects the trained model update from each data owner without collecting the data from each data owner. The response time for each data owner can vary, and a particular data owner may stop responding (i.e., drop out) of a learning session.

### SUMMARY

According to various embodiments, a computer-implemented method, a computing device, and a non-transitory computer readable storage medium communicating in a federated learning environment are provided.

In one embodiment, a computer-implemented method of communicating in a federated learning environment includes a monitoring operation of a plurality of federated learning participants for one or more factors associated with stragglers. The federated learning participants are assigned into tiers based on the monitoring of the one or more factors, each of the tiers having a designated wait time. The aggregator queries the federated learning participants in a selected tier and tracks a response time of the federated learning participants. Late responders are designated as stragglers, and an operation of updating a training of a federated learning model is performed by applying a predicted response for the stragglers including collected participants' replies and computed predictions associated with the stragglers.

In another embodiment, the federated learning participants that do not respond within the designated wait time are designated as drop outs, and the training of the federated learning model is updated with collected participants' replies and computed predictions associated with the drop outs.

In another embodiment, for each round of updating the training of the federated learning model, there is an updating of the designated wait time per tier.

In one embodiment, a computer implemented method of a synchronization based tier includes an aggregator initializing a plurality of federated learning participants in training of a federated learning model. In response to determining that a number of run epochs is less than a number of synchronization epochs (n_syn): responses are received from at least some of the plurality of federated learning participants, and a response time (RTᵢ) is updated until a maximum time (Tₘₐₓ) elapses. In response to determining that a number of run epochs is greater than a number of synchronization epochs the federated learning participants are designated as a drop out when RTᵢ=n_syn * Tₘₐₓ.

In another embodiment, the response times of the drop out participants are removed from the federated learning model. An average reply time is assigned to each tier of a plurality of tiers having a predetermined number of federated learning participants per tier.

In one embodiment, a histogram of remaining responses times is created.

In one embodiment, a computing device includes an aggregator configured for operation in a federated learning system. A processor is configured to monitor a plurality of federated learning participants for one or more factors. The one or more factors of the plurality of federal learning participants being monitored are associated with stragglers. The federated learning participants are assigned into tiers based on the monitored one or more factors, each of the tiers having a designated wait time.

In an embodiment, a communication module is operatively coupled with the aggregator to query the federated learning participants in a selected tier and receive a response. The aggregator is further configured to designate the federated learning participants that respond after a predetermined time within a period of the designated wait time as stragglers. A predicted response is applied for the stragglers including collected participants' replies and computed predictions associated with the stragglers to update a training of a federated learning model.

In another embodiment, a non-transitory computer readable storage medium tangibly embodies a computer readable program code having computer readable instructions that, when executed, causes a computer device to execute a method of communicating in a federated learning environment, the method includes monitoring a plurality of federated learning participants for one or more factors associated with stragglers. The federated learning participants are assigned into tiers based on the monitoring of the one or more factors, each of the tiers having a designated wait time. A selected tier is queried by the aggregator and the federated learning participants that respond late are designated as stragglers. A predicted response for the stragglers is provided including collected participants' replies and computed predictions associated with the stragglers to update a training of a federated learning model.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an example architecture of a federated learning environment consistent with an illustrative embodiment.

FIG. 2 shows examples of response times of various federated learning participants queried by an aggregator including a drop out consistent with an illustrative embodiment.

FIG. 3 shows examples of response times of various federated learning participants queried by an aggregator including at least one straggler consistent with an illustrative embodiment.

FIG. 4A is a block diagram of an aggregator and a communication module consistent with an illustrative embodiment.

FIG. 4B illustrates an overview of a communications scheme for training a federated learning model consistent with an illustrative embodiment.

FIG. 5 illustrates an algorithm for synchronization of a tier-based procedure for identifying drop outs in a federated learning environment consistent with an illustrative embodiment.

FIG. 6 illustrates an algorithm of a training model in a federated learning environment consistent with an illustrative embodiment.

FIG. 7 is a functional block diagram illustration of a computer hardware platform that can communicate with various networked components, consistent with an illustrative embodiment.

FIG. 8 depicts a cloud computing environment, consistent with an illustrative embodiment.

FIG. 9 depicts abstraction model layers, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

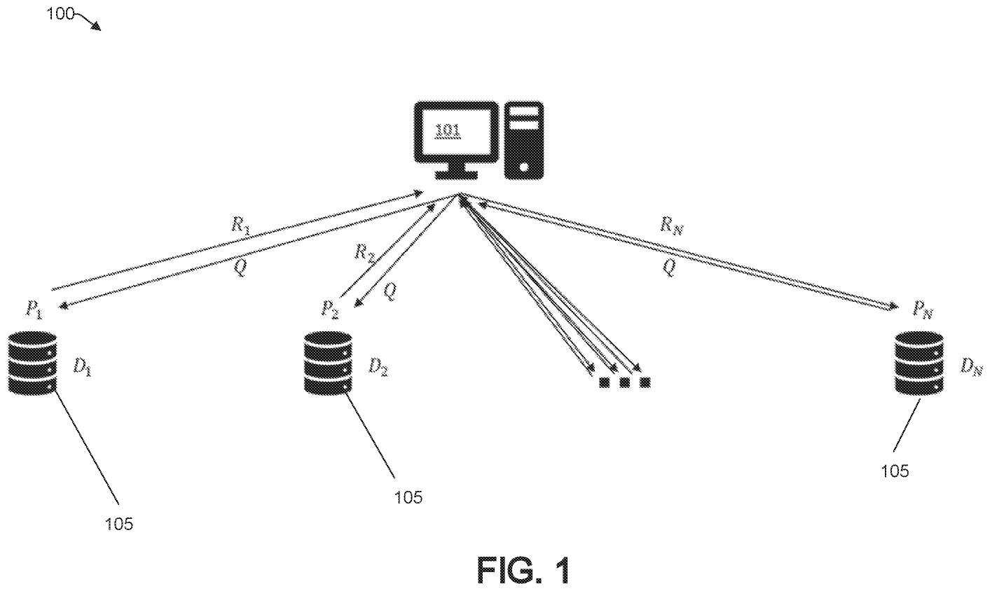

FIG. 1 illustrates an example architecture of a federated learning environment 100 consistent with an illustrative embodiment. Referring to FIG. 1, there are data parties 105 are sharing data with an aggregator 101 to learn a predictive model. Aggregation occurs after each of the data parties has replied. In a federated learning system, multiple data sources collaborate with limited trust between the multiple data sources. There are various reasons that limited trust exists between the parties, including but not limited to competitive advantage, legal restrictions in the U.S. due to the Health Insurance Portability and Accountability Act (HIPPA), and the General Data Protection Regulation (GDPR) in the European Union. In a federated learning system, each data owner maintains its data locally and can engage in a learning procedure in which the model updates are shared with an aggregator so as to avoid sharing training data.

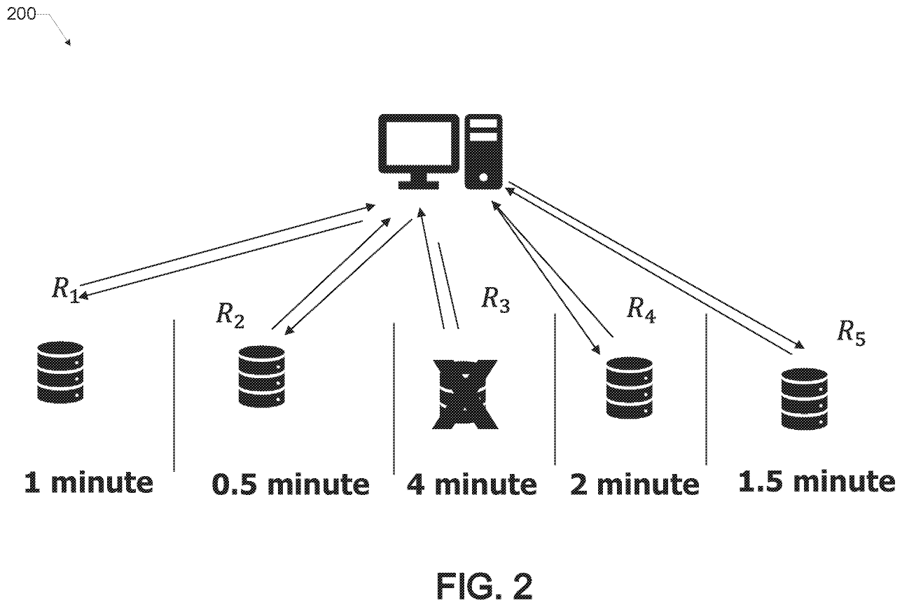

FIG. 2 shows in 200 examples of response times of various federated learning participants queried by an aggregator including a drop out (marked with an X) consistent with an illustrative embodiment. When a data party drops out, the model may be less accurate, or the learning procedure could abort. As the federated learning system is a type of distributed learning system with data/resource heterogeneity from distributed data owners, there is less control and management of the individual data owners than a centralized machine learning system. The different data parties have different types of data, and different amounts of data, thus their contribution of a trained model update to the federated learning model is different. Accordingly, the effects of a drop out can be different depending on the data party/parties that drops out from the collaborative learning operation.

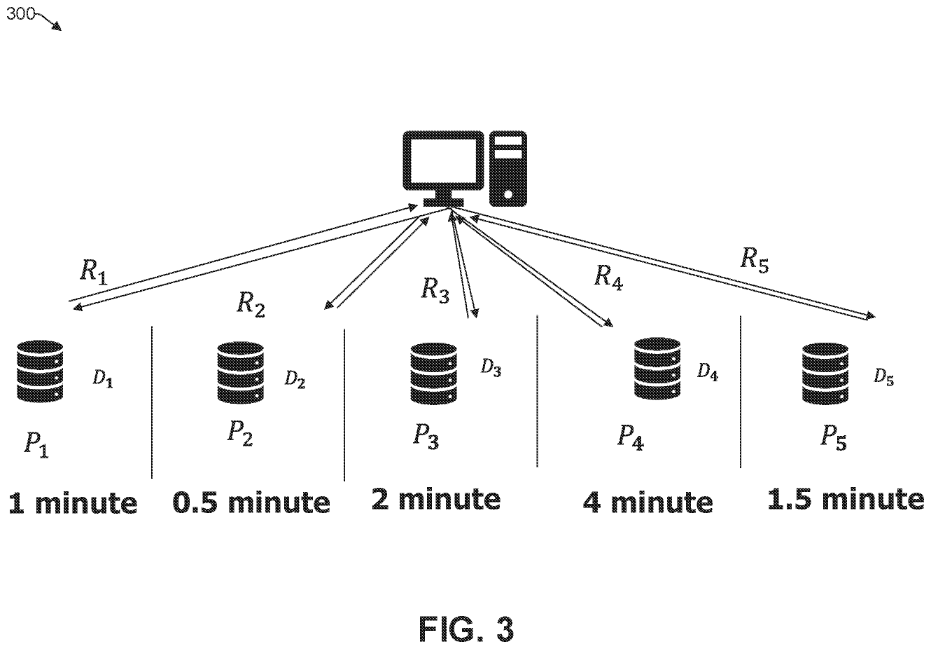

FIG. 3 shows in 300 examples of response times of various federated learning participants queried by an aggregator including at least one straggler consistent with an illustrative embodiment. None of the federated learning participants (e.g. parties) in FIG. 3 shows a case where some of the parties respond to the aggregator slower than some of the other parties. For example, referring to FIG. 3, while the response time is 0.5 minutes for P2, the response for P4 is 4 minutes. Thus, P4 is considered a straggler. The federated learning process is slowed by waiting for the replies from the stragglers. The federated learning process is also slowed by waiting for replies from federated learning participants which have dropped out such as shown in FIG. 2. The aggregator determines that some of the federated learning participants are drop outs from the lack of response to a query. Thus, waiting for a predetermined time to receive a response to a query, and then determining by the lack of a reply to the query that a federated learning participant is a drop out, increases the communication overhead.

In cases where there are either data drop out, or data stragglers, or both, the aggregator may query all the data parties with a single data drop out or straggler. As discussed herein below, several embodiments of the present disclosure provide a hybrid scheme for federated learning that identifies and predicts data parties having slow responses (stragglers) and ways to mitigate the effect of the stragglers. In some embodiments of the present disclosure drop out parties are identified and ways to mitigate the effect of dropped out data parties without adversely impacting, or minimizing the impact of the federated learning process rate.

Some of the embodiments of the present disclosure, as discussed herein, provide for a more efficient federated learning process that can train a federated learning model more quickly and accurately. In addition, some embodiments of the present disclosure provide for an improved computer operation as communication overhead is reduced by the aggregator operation in querying the participants of a selected tier and by providing a predicted response for the stragglers including collected participants' replies a and computed predictions associated with the stragglers to update the training of a federated learning model.

### Example Architecture

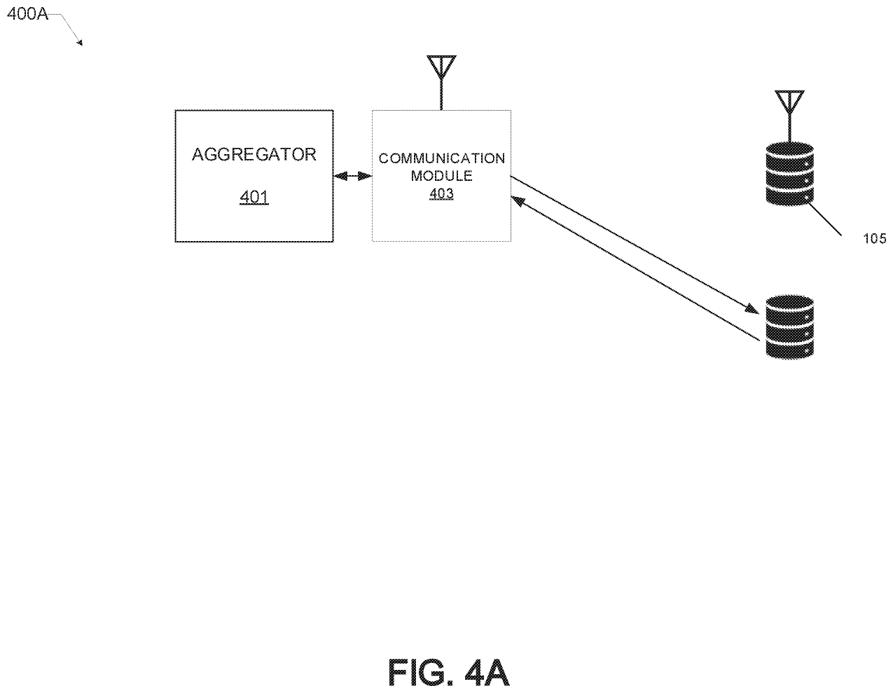

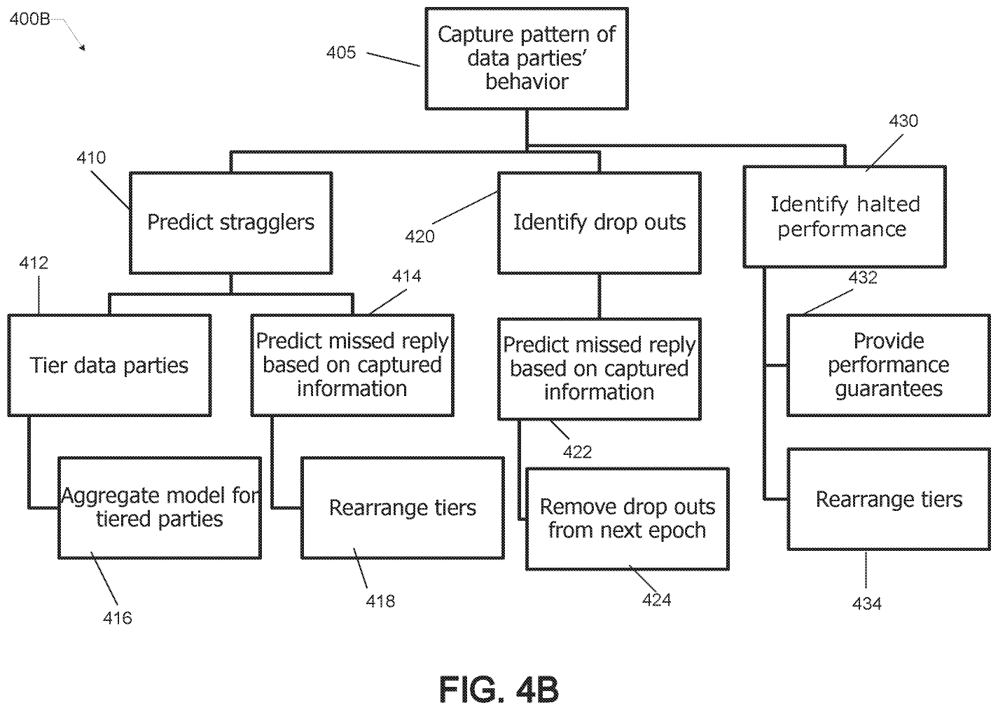

FIG. 4A illustrates an example architecture 400A of an aggregator 401 comprising a processor configured for operation, and a communication module 403 operatively coupled thereto. The communication module is configured to send and receive communications to the various federated learning participants (e.g., data parties). It is to be understood that the architecture shown in FIG. 4A is provided for illustrative purposes only.

### Example Processes

FIG. 4B provides an overview 400B of the operations that may be performed in a computer-implemented method or a computing device configured to operate according to various embodiments of the present disclosure. In the overview presented in FIG. 4B, at 405 there is a pattern of the behavior of the data parties (federated learning participants) that is captured. For example, a particular one of the federated learning participants may answer relatively earlier than the other federated participants. Thus, when other federated learning participants have already responded to a query but the particular one of the federated learning participants has not yet responded, this behavior pattern is different from the previously captured behavior patterns, and the aggregator may query the particular federated participant learning participant, or begin updating the learning model with a predicted response. In a federated learning environment, there can be diversity in the various data parties both in terms of volume and the type of data.

The predicting of stragglers 410, the identifying of drop outs 420, and the identifying halted performances 430 address some of the various aspects of the federated learning environment. For example, with regard to the predicting of stragglers 410, at 412 the data parties may be arranged into tiers. In an embodiment, a tier is randomly selected 4, and then there are randomly selected parties to perform aggregation. Based on the captured pattern of the data parties 405, there can be performed an identification/prediction of data parties with slow responses (stragglers), and an operation to mitigate the effect of stragglers. There can be an aggregate model for tiered data parties. The selected tier for querying can be selected by a randomizing procedure.

In an embodiment, prior to the passage of a predicted response time, the collected data or predicted data can be used to update the learning model to result in a reduced/eliminated delay,

With continued reference to the overview shown in FIG. 4B, missed replies can be predicted based on captured information 414 and the tiers can be rearranged. Drop outs can be identified 420 based on the captured patterns of the data parties behavior, and predictions of missed replies 422 based on captured information. At 424, drop outs are removed from the next epoch to increase a training speed of the federated learning model.

At 430, there can be identification of a halted performance, performance guarantees 432 can be provided, and the tiers 434 can be rearranged.

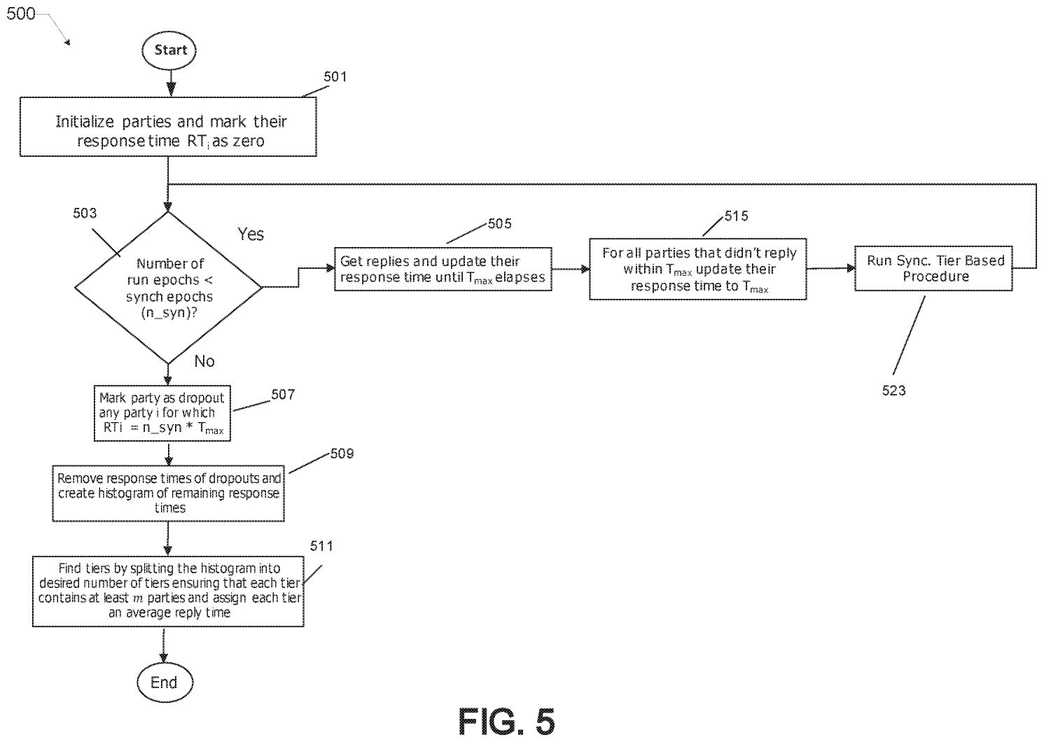

FIG. 5 illustrates an algorithm 500 for synchronization of a tier-based procedure for identifying drop outs in a federated learning environment consistent with an illustrative embodiment.

At operation 501, the process begins and the data parties are initialized and their response time is set to zero. At operation 503, it is determined whether the number of run epochs are less than the number of synch epochs (n_syn). If the number of run epochs are less than the synch epochs (n_syn), at operation 505, replies are retrieved and the response time of the various data parties is updated time until Tₘₐₓ elapses. At operation 515, for all data parties that didn't reply to the aggregator within Tₘₐₓ, their response time is updated to Tₘₐₓ. At 523, the sync tier based procedure is run again and operation 503 is performed again. If at operation 503 it is determined that the number of run epochs is not less than synch epochs, then at 507 the data parties are marked as a drop out for any party “I” for which RTi=n_syn * Tₘₐₓ. At 509, the response times of the drop outs are removed and a histogram is created of remaining response times. At 511, the histogram is split into a desired number of tiers ensuring that each tier has at least “m” parties and assigns each tier an average reply time. The algorithm then ends.

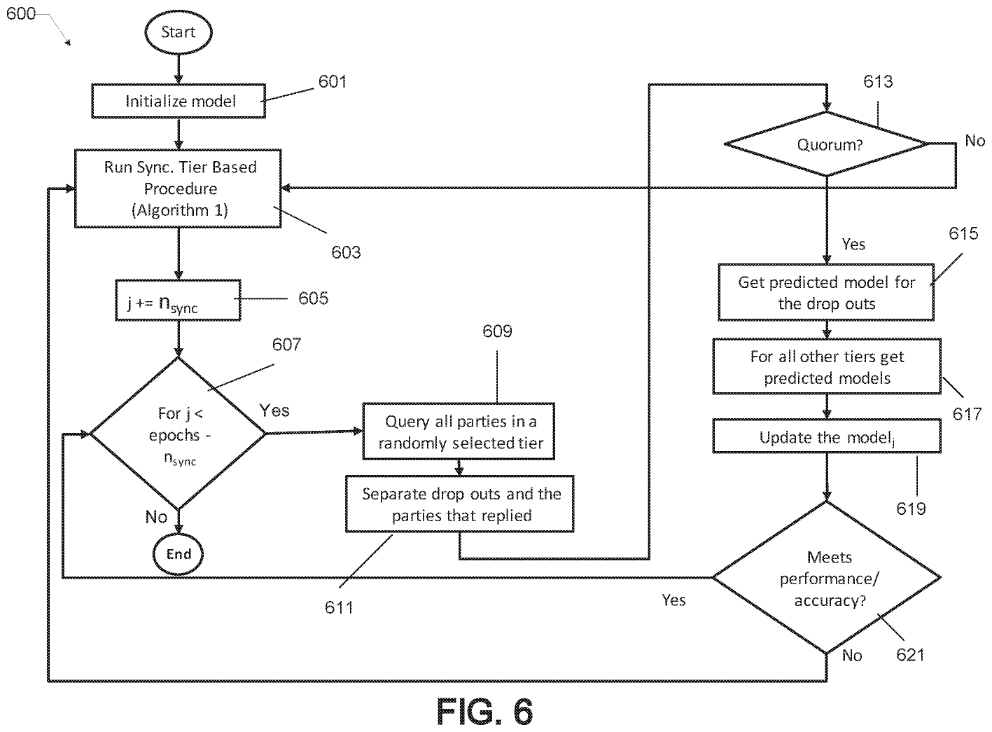

FIG. 6 illustrates an algorithm 600 of a training model in a federated learning environment consistent with an illustrative embodiment.

At operation 601, the training model is initialized. At 603, the synch tier based procedure (algorithm shown in FIG. 5) is run. At 603, the synch tiering is (j+=n_{sync}). It is determined at 607 whether j<n_{Synch}. If it is determined at operation 607 that j is less than the epochs-n_{sync}, then all the parties in a randomly selected tier are queried. At 611, the drop outs and the parties that replied are separated.

If at operation 613 it is determined that a quorum is present, then at operation 615 the predicted model for the drop outs is retrieved. A quorum refers to the minimum number of parties which perform the same action for a given transaction in order to decide the final operation for that transaction. At operation 617, predicted models are obtained for all the other tiers. At operation 619, the training model is updated. Finally, at 621, it is determined whether the training model meets performance/accuracy goals. If the training model does meet the performance accuracy goals, then at 607 it is again determined if j<epochs-n_{sync}. If not, at operation 603, the run sync tier based procedure is performed again.

Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process. For discussion purposes, the processes 300 and 400 are described with reference to the architecture 100 of FIG. 1.

### Example Computer Platform

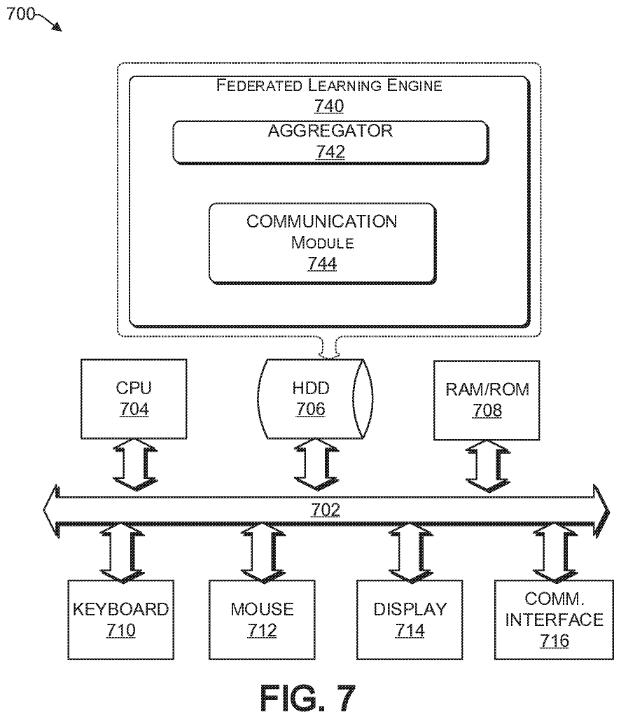

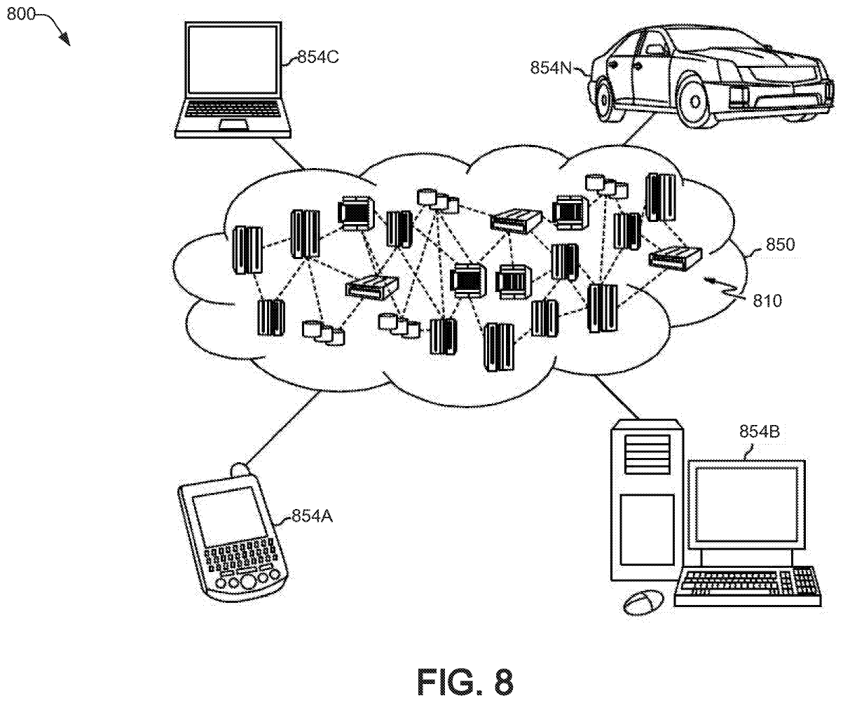

As discussed above, functions relating to federated learning can be performed with the use of one or more computing devices connected for data communication via wireless or wired communication, as shown in FIG. 7 and in accordance with the processes of FIGS. 5 to 6, respectively. FIG. 7 provides a functional block diagram illustration 800 of a computer hardware platform that is capable of participating in federated learning, as discussed herein. In particular, FIG. 8 illustrates a network or host computer platform 800, as may be used to implement an appropriately configured server.

The computer platform 700 may include a central processing unit (CPU) 704, a hard disk drive (HDD) 706, random access memory (RAM) and/or read only memory (ROM) 708, a keyboard 710, a mouse 712, a display 714, and a communication interface 716, which are connected to a system bus 702.

In one embodiment, the HDD 706, has capabilities that include storing a program that can execute various processes, such as the federated learning engine 740, in a manner described herein. The federated learning engine 740 may have various modules configured to perform different functions. For example, there is an aggregator 742 that communicates with federated learning data parties (e.g. federated learning participants) via a communication module 744 that is operative to transmit and receive electronic data from the federated learning data parties.

In one embodiment, a program, such as Apache™, can be stored for operating the system as a Web server. In one embodiment, the HDD 506 can store an executing application that includes one or more library software modules, such as those for the Java™ Runtime Environment program for realizing a JVM (Java™ virtual machine).

### Example Cloud Platform

With reference to FIG. 8, the functions discussed above relating to managing the operation of one or more client domains, may include a cloud 850. It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring again to FIG. 8, in 800 an illustrative cloud computing environment is depicted. As shown, a cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, orHybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

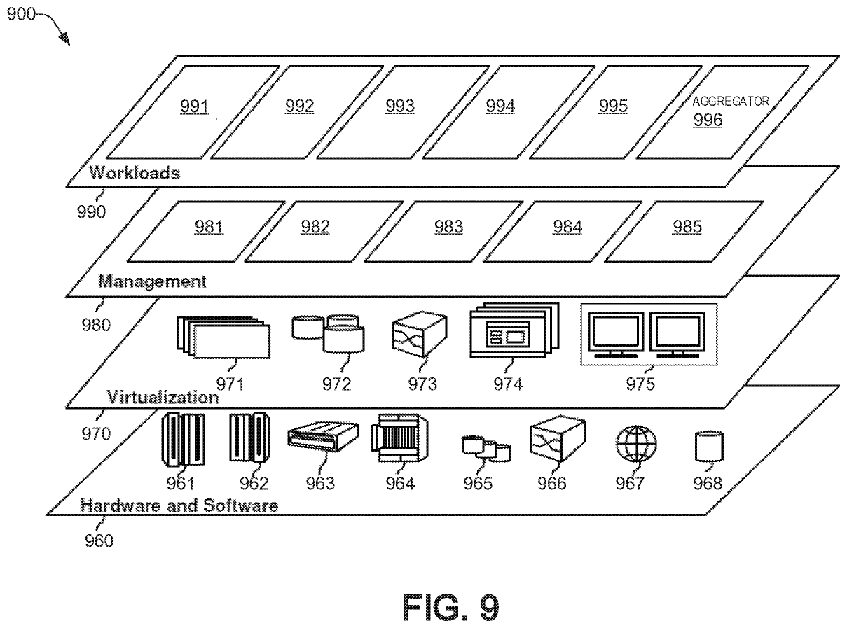

Referring now to FIG. 9, a set of functional abstraction layers 900 provided by cloud computing environment 850 (FIG. 8) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 960 includes hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and managing operation of an aggregator 996, as discussed herein.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of communicating in a federated learning environment, the method comprising:
monitoring a plurality of federated learning participants for one or more factors associated with stragglers;
assigning the federated learning participants into tiers based on the monitoring of the one or more factors, each of the tiers having a designated wait time;
querying the federated learning participants in a selected tier;
designating the federated learning participants that respond after a predetermined time within the designated wait time as stragglers; and
updating a training of a federated learning model by applying a predicted response for the stragglers including collected participants' replies and computed predictions associated with the stragglers.

2. The computer-implemented method according to claim 1, further comprising:
identifying the federated learning participants that do not respond within the designated wait time as drop outs; and
updating the training of the federated learning model with collected participants' replies and computed predictions associated with the drop outs in response to identifying whether a quorum of federated learning participants has responded to the querying.

3. The computer-implemented method according to claim 2, wherein for each round of updating the training of the federated learning model, updating the designated wait time per tier, and the method further comprising:
determining an accuracy of the training of the federated learning model according to one or more predetermined criteria, and
terminating an asynchronized training stage of the federated learning model when the accuracy does not increase after a predetermined number of asynchronization time periods.

4. The computer-implemented method according to claim 1, wherein the selected tier for querying is selected by a randomizing procedure.

5. The computer-implemented method according to claim 1, further comprising:
periodically updating the training of the federated learning model with the collected participants' replies and computed predictions of the stragglers.

6. The computer-implemented method according to claim 1, further comprising:
updating the monitoring of the federated learning participants; and
determining whether to reassign the federated learning participants into different tiers, based on the updated monitoring for each synchronization time period of a plurality of synchronization time periods.

7. The computer-implemented method of claim 1, further comprising:
dynamically rearranging the tiers based on updated monitoring of the federated learning participants.

8. The computer-implemented method according to claim 1, further comprising:
applying a prediction step to aggregate responses from the federated learning participants of the selected tier that respond to the querying with information from the federated learning participants in non-selected tiers as follows:
G^{k+1}=G^{k}+pᵢ⁻¹ [AVG(replies)−AVG(mostRecent_repties)]
wherein:
G^{k} is an aggregation result from a last epoch;
pᵢ is a corresponding probability to a queried tier tᵢ;
replies are received replies from the queried tier tᵢ, and
mostRecent_replies are a most recent replies from the queried tier tᵢ.

9. A computer-implemented method of communicating in a federated learning environment, the method comprising:
initializing a plurality of federated learning participants in training of a federated learning model; and
(a) in response to determining that a number of run epochs is less than a number of synchronization epochs (n_syn):
receiving responses from at least some of the plurality of federated learning participants; and
updating a response time (RTi) until a maximum time (Tmax) elapses;
(b) in response to determining that a number of run epochs is greater than a number of synchronization epochs:
identifying a federated learning participant from the plurality of federated learning participants as a drop out for which RTi=n_syn * Tmax;
removing response times of the drop out and create a histogram of remaining response times; and
assigning an average reply time to each tier of a plurality of tiers having a predetermined number of federated learning participants per tier.

10. The computer-implemented method according to claim 9, wherein when the number of run epochs is greater than the number of synchronization epochs, the method further comprising:
creating a histogram of remaining response times; and
dividing the histogram into the plurality of tiers including the plurality of federated learning participants.

11. The computer-implemented method according to claim 9, further comprising:
updating a response time to Tmax for the federated learning participants from which responses were not received by an aggregator when the number of run epochs is less than a number of synchronization epochs (n_syn).

12. A non-transitory computer readable storage medium tangibly embodying a computer readable program code having computer readable instructions that, when executed, causes a computer device to execute a method of communicating in a federated learning environment, the method comprising:
monitoring a plurality of federated learning participants for one or more factors associated with stragglers;
assigning the federated learning participants into tiers based on the monitoring of the one or more factors, each of the tiers having a designated wait time;
querying the federated learning participants in a selected tier;
designating the federated learning participants that respond after a predetermined time within the designated wait time as stragglers; and
applying a predicted response for the stragglers including collected participants' replies and computed predictions associated with the stragglers to update a training of a federated learning model.

13. The computer readable storage medium according to claim 12, further comprising:
identifying the federated learning participants that do not respond within the designated wait time as drop outs; and
updating the training of the federated learning model with collected participants' replies and computed predictions associated with the drop outs in response to identifying whether a quorum of federated learning participants has responded to the querying.

14. The computer readable storage medium according to claim 13, wherein the monitoring of the plurality of federated learning participants further comprises capturing behavior patterns of the federated learning participants.

15. The computer readable storage medium according to claim 14, further comprising identifying at least one of the drop outs or predicting at least one of the stragglers based on the captured behavior patterns of the federated learning participants.

16. The computer readable storage medium according to claim 12, further comprising:
applying a prediction step to aggregate responses from the federated learning participants of the selected tier that respond to the querying with information from the federated learning participants in non-selected tiers as follows:
G^{k+1}=G^{k}+pᵢ⁻¹[AVG(replies)−AVG(mostRecent_replies)]
wherein:
G^{k} is an aggregation result from a last epoch;
pᵢ is a corresponding probability to a queried tier tᵢ;
replies are received replies from the queried tier tᵢ; and
mostRecentPreplies are a most recent replies from the queried tier tᵢ.

17. The computer readable storage medium according to claim 12, further comprising:
dynamically rearranging the tiers based on an updated monitoring of the federated learning participants.

18. The computer readable storage medium according to claim 12, further comprising:
periodically updating the training of the federated learning model with the collected participants' replies and computed predictions of the stragglers.

19. The computer readable storage medium according to claim 12, wherein the selected tier for querying is selected by a randomizing procedure.

20. The computer readable storage medium according to claim 12, further comprising:
determining an accuracy of the training of the federated learning model according to one or more predetermined criteria; and
terminating an asynchronized training stage of the federated learning model when the accuracy does not increase after a predetermined number of asynchronization time periods.
